(19) United States
(12) Patent Application Publication
(10) Pub. No.: US 2017/0240736 A1
(43) Pub. Date: Aug. 24, 2017

(54) POLYVINYLCHLORIDE FOR SEAMLESS AIRBAG DOORS

(71) Applicant: Cpk Interior Products, Corbyville (CA)

(72) Inventor: Gregory Farrar, Roblin (CA)

(21) Appl. No.: 15/051,217

(22) Filed: Feb. 23, 2016

(51) Int. Cl. C08L 27/06; C08K 5/11; B60R 21/215; C08K 5/103

(52) U.S. Cl. CPC C08L 27/06; C08K 5/103; C08K 5/11; B60R 21/215; C08L 2205/06; C08L 2201/08; B60R 2021/21537

(57) ABSTRACT

The present invention relates to a highly plasticized PVC formula that can be both dry blended and if desired, alloyed with acrylonitrile butadiene rubber to produce enhanced haptic material characteristics for a vehicle interior trim component. This blend/alloy can be made using high intensity mixers without the need for melt processing and grinding processes. “Dry blending” techniques allow the spherical particles from suspension grade PVC resins to be retained during the blending process, resulting in a final product with superior flow-ability in comparison to other low temperature deployable grade PVCs in the marketplace.

### FIELD

The present invention relates to a polyvinylchloride (PVC) compound and more particularly to a PVC dry blend can be alloyed and used in vehicle interior applications such as seamless airbag doors.

### BACKGROUND

This section provides background information related to the present disclosure which is not necessarily prior art.

Currently, interior trim components such as instrument panel skins can be made from a variety of polymeric materials including but not limited to polyvinyl chloride (PVC), thermoplastic polyurethane (TPU), thermoplastic polyolefin (TPO), and thermoplastic elastomers (TPEs). These skins can be made by methods such as rotational molding and male/female thermoforming.

In the past, PVC and PVC alloyed materials were used for separate airbag doors for instrument panel constructions. More recently, U.S. Pat. No. 7,560,515 discusses PVC alloy combined with a cross-linked olefin based thermoplastic elastomer for use as an instrument panel coverstock. This type of PVC material results in good low temperature performance, specifically in regards to airbag deployments with no skin fragmentation at −20° C.

Prior art has demonstrated that prolonged heat age testing at 110° C. for 500 hours can be used to predict the performance of an aged instrument panel in the field. The 515′ patent specifically mentions that PVC blends/alloys exhibit reductions of their original physical properties and tend to become brittle over time. It is generally believed, that the main contributing factor for the loss of physical properties is due to the migration of plasticizer from PVC.

Generally, the use of low molecular weight plasticizers such as dioctyl phthalate (DOP, Mw=390.6 g/mol), diisononyl phthalate (DINP, Mw=418.6 g/mol), dioctyl terephthalate (DOTP, Mw=390.6 g/mol), and 1,2-Cyclohexane dicarboxylic acid diisononyl ester (Mw=424.7 g/mol) in PVC can result in materials that become brittle over time. It is possible that this degradation of material properties can result in poor low temperature performance. The main advantages of using lower molecular weight plasticizers are that they offer increased compatibility with PVC and have lower viscosities which lead to better process-ability. Increasing the molecular weight of the plasticizer generally reduces its compatibility with PVC, results in higher viscosities, and also gives poorer process-ability. It does however result in less plasticizer migration and better low-temperature flexibility and performance over time. The 515′ patent specifically references an 11-carbon length chain diundecyl phthalate (DUP, Mw=474.7 g/mol) as giving good low temperature performance after ageing.

At present, PVC blends and alloys that are used to produce seamless airbag door applications with good low temperature performance for the slush molding process are made through melt compounding and powder grinding technologies. The ingredients, if desired, can be blended and mixed using a Banbury mixer, by milling, or through extrusion processes and are then pelletized and ground into fine particles using specialized equipment. Grinding technologies can include: cryogenic grinding, pulverizing, wet/dry milling, and the like.

It would be extremely desirable if a PVC blend and/or alloy that overcame the previously mentioned deficits and could be produced for slush molding applications in fewer process steps and eliminated the need for expensive grinding technologies.

### SUMMARY

This section provides a general summary of the disclosure, and is not a comprehensive disclosure of its full scope or all of its features.

The present teachings relate to a highly plasticized PVC formula that can be both dry blended and alloyed with acrylonitrile butadiene rubber to produce enhanced haptic material characteristics. This blend/alloy can be made using high intensity mixers without the need for melt processing and grinding processes. “Dry blending” techniques allow the spherical particles from suspension grade PVC resins to be retained during the blending process, resulting in a final product with superior flow-ability in comparison to other low temperature deployable grade PVCs in the marketplace.

According to the present teaching, an interior trim component having an integrated air bag door is presented. The interior trim component has a skin placed over a substrate 12. The skin is formed of a highly plasticized PVC formula having two differing plasticizers. One of the plasticizers used herein can be aliphatic based and comprise between 25-50% by weight of the blend formulation.

According to another teaching, an interior trim, component having an air bag door is presented. The air bag door has a skin placed over a substrate 12. The skin is formed of a highly plasticized PVC formula having an acrylonitrile butadiene rubber utilized from between 0-10% by weight of the total blend formulation and contributes to the materials haptics.

According to the present teaching, an instrument panel having a seamless air bag door is presented. The air bag door has a skin placed over a substrate 12 defining a hinged door. The skin is formed of a polyvinylchloride (PVC) dry blend, can include a pair of plasticizers having different viscosities. One of the plasticizers can be aliphatic based and can be combined with synthetic rubbers if desired.

According to another teaching, an instrument panel having a seamless air bag door is presented. The air bag door has a skin placed over a substrate 12 defining a hinged open-able member. The skin is formed of a polyvinylchloride (PVC) dry blend, and has at least two plasticizers and can be combined with synthetic rubbers. The combination of plasticizers results in a both good high and low temperature performance.

According to the present teaching, an instrument panel having a seamless air bag door is presented. The air bag door has a skin placed over a substrate 12. The skin is formed of a polyvinylchloride (PVC) dry blend, and can comprise an aliphatic based plasticizer that can be combined with synthetic rubbers. The skin can be pre-weakened along a predefined tear pattern on an inside skin face.

According to the present teaching, an interior trim component for a vehicle is made using the process. Add all solid components into Henschel and mix on low speed for 3 minutes for pre-heating purposes. After 3 minutes, 70% of the Pevalen is added into the mixer, stirring at low speed. The speed of the mixer is increased and the material is mixed until it reaches 190 F. At 190 F, the remaining 30% of Pevalen is added along with UV, light, and stabilizers on low speed. A second plasticizer can also added at this time. The mixer is then turned to high speed and mixed until it reaches 235 degrees F. The material is then cooled to 120 F where the drying agent is then added and an additional cooling period to about 105 F allows for the addition of rubber.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B represent a seamless an bag door according to the present teachings; and

FIG. 2 represents a flow chart disclosing the steps to produce the material of the present teachings.

Corresponding reference numerals indicate corresponding parts throughout the several views of the drawings.

### DETAILED DESCRIPTION

Example embodiments will now be described more fully with reference to the accompanying drawings. As previously discussed, the present teachings relates to a PVC blend/alloy comprising a highly flexible PVC produced from polyol ester based plasticizers and can be alloyed with acrylonitrile butadiene rubber.

The formula described herein can be compounded on high intensity mixers without the need for additional melt processing and grinding steps, resulting in a lower cost PVC alternative for seamless airbag interior trim applications. The following example provides guidance on the relative formulations that fall within the scope of the present teachings:

| | | |
|---|---|---|
| PVC Suspension resin | 100 | grams |
| Polyol Ester Plasticizer | 40-100 | grams (preferred 55-75 grams) |
| Adipate Ester Plasticizer | 0-50 | grams (preferred 15-25 grams) |
| Heat Stabilizers | 3.0-5.5 | grams |
| Light Stabilizers | 0.4-1.0 | grams |
| Epoxidized Soybean Oil | 1-10 | grams |
| PVC Dispersion Resin | 5-12 | grams |
| Elastomer | 0-15 | grams (preferred 10 grams) |
| Fillers (Calcium | 0-15 | grams |
| Carbonate, Talc, etc.) | | |

The tensile strength, elongation, and tear strength of the composition used herein does not change by more than ±30% after 500 hours of heat ageing at 110° C. More specifically, the preferred embodiment has does not deviate by more than ±25%. Physical properties were also performed at −30° C. as indicator for cold weather airbag deployments. Un-aged physical properties at −30° C. were in good agreement to the room temperature properties with an elongation value greater than 300%, which is an indicator that this material should not fragment during airbag deployments at this temperature.

Typical PVC suspension grade resins that can be used have an inherent viscosity of 0.900-1.10 dl/g, a K-value of 65-73, and a porosity of 0.30-0.35 cc/g. The preferred suspension grade resin is Oxy 220 F from Occidental Petroleum Corporation.

The preferred plasticizer is an ester which is formed by the reaction of pentaerythritol and valeric acid and goes by the trade name of Pevalen and is produced by Perstorp Ab (U.S. patent application 20150203657 A1). Pevalen has been marketed as a plasticizer for sensitive applications (medical instruments, toys, food contact, etc.) and as a phthalate free replacement for DOP. Pevalen has a dynamic viscosity of 30-40 cps (@ 20° C.), while linear phthalates such as DUP and trimellitate plasticizers such as tri octyl trimellitate (TOTM) have higher viscosities of 70-80 cps and 240-260 cps respectively. The increase in viscosity of longer chain phthalates and trimellitates decreases their plasticization efficiency and also less desirable due to their added cost.

Possible elastomers can include but are not limited to, NBR rubbers that are copolymers of acrylonitrile and butadiene, such as Chemigum from Omnova Solutions and crosslinked acrylate terpolymers, such as Sunigum also from Omnova Solutions. It is specifically required that the rubber elastomer is ground into finely dispersed particles. The preferred cross-linked nitrile rubber is Zealloy 1422 from Zeon Chemicals and has an acrylonitrile content of 33 wt %.

As VOC's and odors are becoming increasingly important for health and environmental reasons, rubber in different iterations of this material can be removed. According to the present teachings, additional processing for the compound includes the following: 1) The additive/stabilizer package can be to be added in the second pass. It should be noted that if added in the first pass, blend efficiency decreases and blend time increases; 2) The Colourant can be added after the second dry point. Optionally, because of the high plasticizer content, colourant is added later in the blending process so it does not inhibit the absorption of plasticizer in the pours of the PVC during the absorption phase. 3) Rubber can be added without the need for extrusion/grinding. Typically, nitrile butadiene rubbers are only available with large particle sizes and need to be melt-blended with the PVC. Preferably, the rubber can be added after the drying agent, this is because rubber will absorb plasticizer and swell in size. If particles become too big, they do not melt into the material while casting and they also contribute to poorer material flow-ability.

After casting, the average material thickness in the air-bag region is approximately 1.16 mm. The normal tolerance is 1.016-1.270 mm. A defined tear seam 16 can be formed using a laser or a knife. After scoring, the tear seam 16 material remaining is between 0.457-0.66 mm with an average of 0.60 mm. Although a thinner tear seam 16 is available, below 0.457 mm, the score line will read through to the surface of the instrument panel. Upon compounding, the material has a glass transition value of between 30° C. and -60° C. an angle of repose (AOR) value of between 26° and 34°.

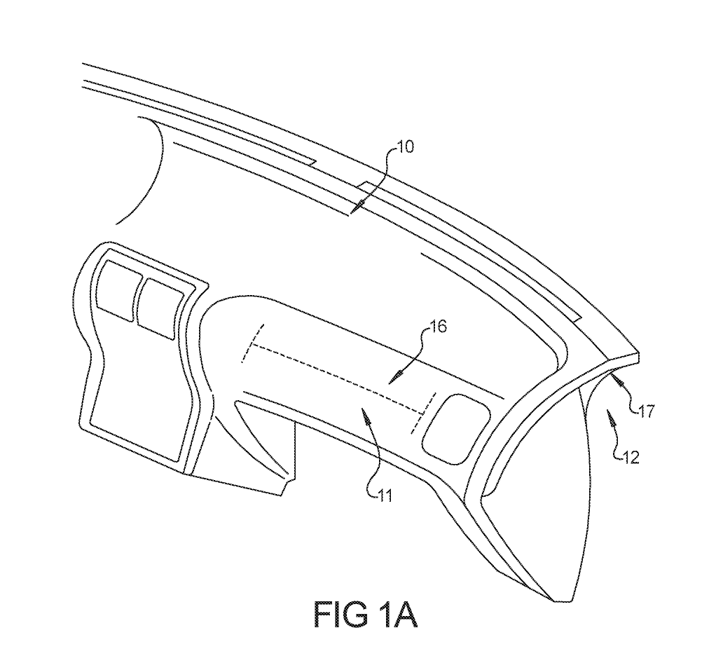

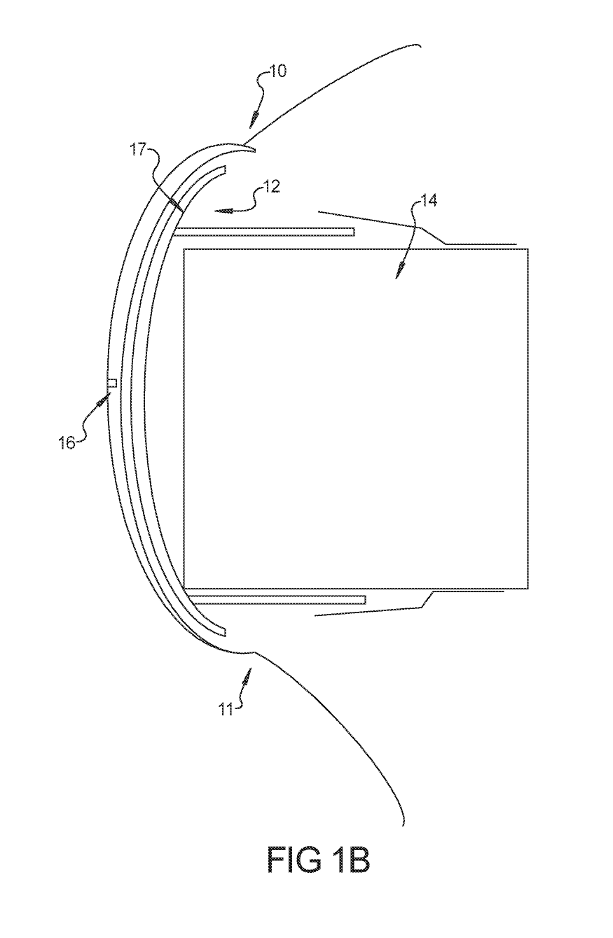

FIGS. 1A and 1 B represent an interior trim component having an integrated air bag door 10, an inflator module, and support structure (not shown). The airbag door 10 has a substrate 12 and a skin 11. Disposed behind the air bag door is an air bag module 14 having an inflatable air cushion as is known in the art. The air bag door 10 has foam 17 disposed between the skin 11 and the substrate 12. The skin 11 is formed of the previously mentioned highly plasticized PVC formula having two differing plasticizers. One of the plasticizers in the skin used herein can be aliphatic based and comprise between 25-50% by weight of the blend formulation. The skin 11 is formed of a highly plasticized PVC formula having an acrylonitrile butadiene rubber utilized from between 0-10% by weight of the total blend formulation and contributes to the materials haptics.

According to the present teaching, an instrument panel having a seamless air bag door is presented. The air bag door has a skin placed over a substrate 12 defining a hinged door. The skin is formed of a polyvinylchloride (PVC) dry blend, can include a pair of plasticizers having different viscosities. The interior trim components can be an instrument panel having a seamless air bag door, a door panel, an A or B pillar trim cover, or a component of a seat or console. The substrate 12 defines a hinged open-able member and defines an opening or tear region. The polyvinylchloride (PVC) dry blend skin containing the polyol ester plasticizer can have a tear seam defined therein. As described above, the tear seam 16 can be formed using a laser or a knife. After scoring, the tear seam 16 material remaining is between 0.457-0.66 mm with an average of 0.60 mm. Although a thinner tear seam 16 is available, below 0.457 mm, the score line will read through to the surface of the part.

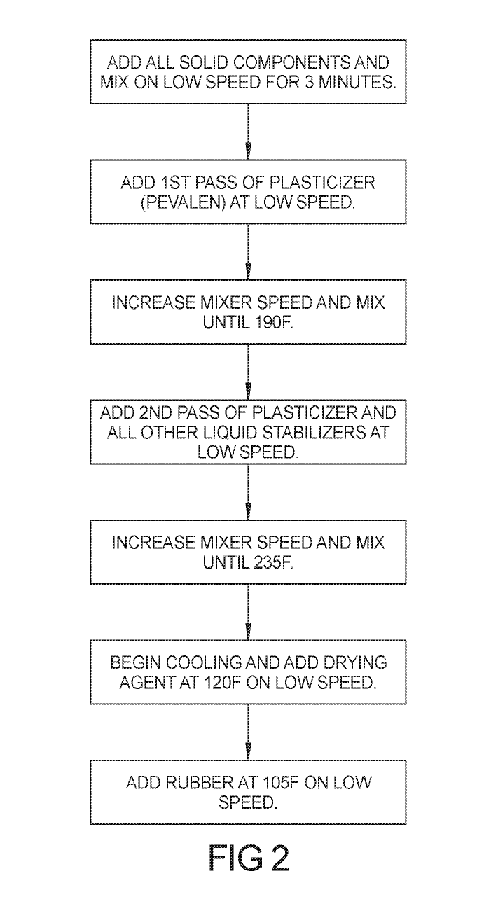

As shown in FIG. 2, the skin material 10 can be formed using the following process. Add all solid components into Henschel and mix on low speed for 3 minutes for pre-heating purposes. After about 3 minutes, 70% of the first plasticizer (Pevalen) is added into the mixer, stirring at low speed. The speed of the mixer is increased and the material is mixed until it reaches greater than 190 F. At this temperature, the remaining 30% of first plasticizer (Pevalen) is added along with UV, light, and stabilizers on low speed. A second plasticizer can also added at this time. The mixer is then turned to high speed and mixed until it reaches 235 degrees F. The material is then cooled to less than 120 F where the drying agent is then added and an additional cooling period to about 105 F allows for the addition of rubber.

According to the present teachings, an instrument panel can be formed of a substructure defining a hinged door. Disposed over the substructure is a skin material defining a tear seam disposed over the hinged door. The skin material has from 35-60 wt. percent of PVC resin, and 25-50 wt. percent of polyolester plasticizer. The polyolester plasticizer can have a molecular weight between 400-500 or higher. Upon deployment of the airbag, no skin fragmentation occurs from an airbag deployment at −30° C. and a 2-minute delay. The elongation of the skin material does not change by more than ±30% after heat ageing at 110° C. The tensile strength of the skin material does not change by more than ±30% after heat ageing at 110° C. Furthermore, a tear strength tear seam does not change by more than ±30% after heat ageing at 110° C.

The angle of repose is a simple test that can be used to determine a materials ability to flow under normal atmospheric conditions. Powders can be divided by several flow-ability classes but for general purposes; below an angle of 30° indicates the material will have excellent flow properties, below 40° results in fair flow properties, and above 45 indicates poor material flow properties. A flexible PVC materials ability to flow can be attributed to many factors including; the coefficient of friction, its density, the size/shape/porosity of the particles, and the content and type of resin and plasticizer systems used. Highly plasticized PVC's made for instrument panel applications with good cold temperature performance have high angles of repose (over 45°), which lead to poor material flow-ability, increased scrap, and reduces the geometry freedom for a given part design. The material described herein using the polyolester plasticizer has excellent flow properties, leading to lower scrap, increased design freedom, and improved grain structure. The Angle of Repose (AOR) value for this material is 30±4° of the material.

According to the present teachings, a material composition for an interior trim component has from 35-60 wt. percent of PVC resin, and 20-45 wt. percent of polyolester plasticizer, and 5-18 wt. percent of an adipate ester plasticizer. The polyolester plasticizer has a molecular weight between 400-500. The adipate ester plasticizer can have a minimum molecular weight of 400. The elongation of the material does not change by more than ±30% after heat ageing at 110° C. The tensile strength of the material does not change by more than ±30% after heat ageing at 110° C. Additionally, the 1-10 wt. percent of an acrylonitrile butadiene rubber, where the rubber is a finely ground powder with a glass transition values of −15° C. to −40° C.

According to the present teachings, a method of forming a material includes adding PVC resin into a mixer, stir at low speed to increase material temperature and blending efficiency. Next, 70% of the total amount of first plasticizer is added to the mixer and mix on high speed to increase material temperature to greater than 180 F. The mixer is then set at low speed where the remaining first plasticizer, second plasticizer, UV, light, heat stabilizers, etc. are added. The mixer is then turned to a high speed until the temperatures of the material is raised to greater than 225 degrees F. The material is cooled while mixing on low to medium speed. Drying agent at less than 130 degrees F. is then added. The rubber is added to the mixer after adding the drying agent. As described above, the first plasticizer is Pevalen and the second plasticizer is an adipate ester.

| Pass: | Material: | PHR | Mass (g) | Comments: |
|---|---|---|---|---|
| 1 | Oxy 220F | 100 | 45,359.2 | Add all components into |
| | | | | Henschel and mix on low |
| | | | | speed for 3 minutes. |
| 2 | Pevalen | 45 | 20,411.66 | Add into the Henschel while |
| | | | | stirring at low speed. Addition |
| | | | | should be done slowly and |
| | | | | take ~2 minutes. |
| | | | | Turn Henschel to high speed |
| | | | | and stir until 190 F. At 190 F, |
| | | | | reduce to low speed. |
| 3 | ESO | 2 | 907.18 | Add the mixed liquid into the |
| | Plaschek | | | Henschel while stirring at low |
| | 775 | | | speed. Addition should be |
| | Tinuvin 213 | 0.4 | 181.44 | done slowly. Turn Henschel |
| | Tinuvin 765 | 0.4 | 181.44 | to high speed and mix |
| | ThermChek | 4 | 1,814.37 | until 235 F. |
| | 79L | | | Add Pass 4 (colourant) |
| | ThermChek | 0.25 | 113.4 | at 215 F. |
| | 406L | | | At 235F, begin cooling by |
| | Plasthall CF | 25 | 11,339.81 | sending material to cooling |
| | Pevalen | 20 | 9,071.85 | mixer and mix at low speed. |
| 4 | Colourant | 1.2 | 544.31 | |
| 5 | Geon 124a | 10 | 4,535.92 | Add at 120 F. |
| | (drying | | | |
| | agent) | | | |
| 6 | Zealloy 1422 | 10 | 4,535.92 | Add at 105 F. Allow to mix |
| | (rubber) | | | for 3-5 minutes. |

When mixed, spherical particles can be formed having a size distribution of:

| | Opening | |
|---|---|---|
| Sieve | (μm) | % Retained |
| 35 US | 500 | 0-5 |
| 45 US | 355 | 0-5 |
| 60 US | 250 | 0-15 |
| 80 US | 180 | 30-90 |
| 100 US | 150 | 10-35 |
| 120 US | 125 | 0-10 |
| PAN | 0 | 0-5 |

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An instrument panel comprising:
a substructure defining a hinged door;
a skin material defining a tear seam disposed over the hinged door having from 35-60 wt. percent of PVC resin, and 25-50 wt. percent of polyolester plasticizer.

2. The instrument panel of claim 1 wherein the polyolester plasticizer has a molecular weight between 400-500 or higher.

3. The instrument panel of claim 1 wherein there is no skin fragmentation occurs from an airbag deployment at −30° C. and a 2-minute delay.

4. The instrument panel of claim 1 wherein the elongation of the skin material does not change by more than ±30% after heat ageing at 110° C.

5. The instrument panel of claim 1 wherein the tensile strength of the skin material does not change by more than ±30% after heat ageing at 110° C.

6. The instrument panel of claim 1 wherein a tear strength tear seam does not change by more than ±30% after heat ageing at 110° C.

7. The instrument panel of claim 1 the skin further comprises further comprising adipate ester plasticizer.

8. The instrument panel of claim 1 wherein the Angle of Repose (AOR) value is 30±4°.

9. A material composition for an interior trim component comprising:
a. from 35-60 wt. percent of PVC resin;
b. and 20-45 wt. percent of polyolester plasticizer; and
c. 5-18 wt. percent of an adipate ester plasticizer.

10. The composition of claim 9 wherein the polyolester plasticizer has a molecular weight between 400-500.

11. The composition of claim 9 wherein the adipate ester plasticizer has a minimum molecular weight of 400.

12. The composition of claim 9 wherein the elongation does not change by more than ±30% after heat ageing at 110° C.

13. The composition of claim 9 wherein the tensile strength does not change by more than ±30% after heat ageing at 110° C.

14. A material composition for an interior trim component comprising:
a. from 35-60 wt. percent of PVC resin;
b. and 20-45 wt. percent of polyolester plasticizer;
c. 5-18 wt. percent of an adipate ester plasticizer; and
d. 1-10 wt. percent of an acrylonitrile butadiene rubber.

15. The composition of claim 14 wherein the polyolester plasticizer has a molecular weight between 400-500.

16. The composition of claim 14 wherein the adipate ester plasticizer has a minimum molecular weight of 400.

17. The composition of claim 14 wherein the acrylonitrile butadiene rubber is a finely ground powder with a glass transition values of −15° C. to −40° C.

18. The composition of claim 14 wherein the elongation does not change by more than ±30% after heat ageing at 110° C.

19. The composition of claim 14 wherein the tensile strength does not change by more than ±30% after heat ageing at 110° C.

20. A method of forming a material comprising:
add PVC resin into a mixer, stir at low speed to increase material temperature and blending efficiency;
add 70% of the total amount of first plasticizer to the mixer and mix on high speed to increase material temperature to greater than 180 F;
turn mixer to low speed;
add remaining first plasticizer, second plasticizer, UV, light, heat stabilizers, etc. and then turn mixer to high speed;
mix material to greater than 225 degrees F.;
add material to cooling mixer and begin cooling while mixing on low to medium speed;
add drying agent at less than 130 degrees F.

21. The method according to claim 20 further comprising adding rubber to the mixer after adding the drying agent.

22. The method according to claim 20 wherein the first plasticizer is Pevalen.

23. The method according to claim 20 wherein the second plasticizer is an adipate ester.

24. The method according to claim 20 wherein the spherical particles can be formed having a size distribution of:

| | Opening | |
|---|---|---|
| Sieve | (μm) | % Retained |
| 35 US | 500 | 0-5 |
| 45 US | 355 | 0-5 |
| 60 US | 250 | 0-15 |
| 80 US | 180 | 30-90 |
| 100 US | 150 | 10-35 |
| 120 US | 125 | 0-10 |
| PAN | 0 | 0-5 |

25. An instrument panel comprising:
a substructure defining a hinged door;
a skin material defining a tear seam disposed over the hinged door having from 35-60 wt. percent of PVC resin, 20-45 wt. percent of Pevalen plasticizer, and 5-15 wt. percent of an adipate ester plasticizer.

26. The instrument panel of claim 25 wherein the Pevalen plasticizer has a molecular weight between 400-500.

27. The instrument panel of claim 25 wherein there is no skin fragmentation occurs from an airbag deployment at −30° C. and a 2-minute delay.

28. The instrument panel of claim 25 wherein the elongation of the skin material does not change by more than ±30% after heat ageing at 110° C.
